(19) United States
(12) Patent Application Publication
(10) Pub. No.: US 2010/0262525 A1
(43) Pub. Date: Oct. 14, 2010

(54) SOFTWARE SYSTEM FOR FACILITATING USER CREATION OF A LIFE TRUST

(76) Inventor: Lawrence J. Eisenberg, Gaithersburg, MD (US)

Correspondence Address: Russ Weinzimmer, 614 Nashua Street, Suite 53, Milford, NH, 03055, US

(21) Appl. No.: 12/422,493

(22) Filed: Apr. 13, 2009

(51) Int. Cl. G06Q 40/00

(52) U.S. Cl. 705/35

(57) ABSTRACT

A software-implemented system and method are disclosed for enabling user creation of an irrevocable life trust for a child with little or no help from an attorney. The method includes promotion of life trusts, and of the possibility of self-created and self-administered life trusts. The user completes a software-presented template, which is used to provide documents that can be executed to establish a life trust. The software focuses exclusively on life trust creation, thereby minimizing its cost and complexity. In preferred embodiments, administration of the life trust is aided by supporting materials, thereby avoiding long-term software support and upgrade costs. Some embodiments enable a user to invest life trust funds in a tax-deferred annuity without losing the annuity's tax-deferred status. Preferred embodiments include software usage limiting features, such as password protection, watermarks, background shading and other duplication inhibiting features, as well as local and/or remote tracking of template usage.

### FIELD OF THE INVENTION

The invention generally relates to financial planning, and more specifically to systems and methods for creating financial planning documents.

### BACKGROUND OF THE INVENTION

A life trust is an irrevocable trust that is established and funded by a trust establisher (typically a grandparent or parent) for the benefit of a trust beneficiary who is a child (typically a child or grandchild of the establisher, but it could be anyone), so that the trust can grow tax-deferred and asset protected for a very long period of time, typically many decades. Preferably, a life trust is established when the child is still an infant, so that the trust has as much time to grow as possible. The life trust precludes distributions, with certain exceptions (death, disability, unforeseen financial emergency), until the trust beneficiary reaches a specified distribution age in later life, typically age 60 or later. After reaching the specified distribution age, the trust beneficiary may, but is not required, to take distributions from the life trust.

A life trust is a separate legal entity that is designed to help ensure the financial future of children and grandchildren by allowing a small gift or gifts to grow into a very large amount over the child or grandchild's life. Therefore, a life trust is most advantageous when it is created as early as possible in the life of the beneficiary, ideally while the beneficiary is still an infant.

A life trust provides the combined advantages of long-term compounded growth, asset protection, tax-deferral, and low costs (both administrative and investment-related), so as to create a potential for significant, long-term financial wealth. Compound interest provides the potential for substantial wealth creation, since the assets will be allowed to grow over a long period of time. Asset protection helps ensure that the life trust assets cannot be reached by creditors, including ex-spouses. Tax deferral allows faster compounded growth, since no taxes are currently paid on the growth. Lower costs result in more assets being able to grow.

The life trust concept is poorly understood by the general public. In particular, the general public has virtually no understanding of the powerful synergy provided by combination of attributes offered by a life trust. In addition, the general public has very little understanding of the concept that retirement savings are best achieved if a retirement-type vehicle—which is the essence of the life trust—is established as early in life as possible. If retirement savings are tied to employment, the funding and growth of retirement assets is delayed for two decades or more.

In addition to ignorance regarding life trusts and their benefits, another significant barrier that prevents many individuals from establishing life trusts is an inability or unwillingness to pay for the services of an attorney to create the required trust-establishing documents, which can cost several thousands of dollars. In addition, many individuals hesitate to pay for the services of an attorney or other outside person to administer a life trust, which also can cost several thousands of dollars.

One approach that is sometimes used in an attempt to overcome these barriers and enable more individuals to establish life trusts is to provide education and documentation directly to end-users regarding financial management options, thereby enabling them to create their own trusts. For example, some previously disclosed, software-implemented methods provide for the ongoing administration of the financial resources of a user. However, these software-implemented methods are necessarily complex and time-consuming to use, since they mainly focus on the ongoing management of trust investments, rather than on the establishment of the trust entity, and so they require a substantially continuous involvement of the user with the software throughout the life of the trust or other financial instrument.

Another known approach provides a trust creation and administration service that attempts to facilitate the creation of trusts while avoiding most or all of the costs of using an attorney. However, this approach requires a high degree of involvement of outside persons, both in terms of administering the trust, and in terms of long-term management of investments. In particular, this approach requires provision by the method providers of a trust administrator during the lifetime of the trust. This causes the user to remain dependent upon the method providers, and to bear the long term cost of their administration support and for any changes and/or other long term maintenance that may be required.

Known software approaches require a level of interaction with software that is inappropriately sophisticated for creation of a single life trust by a user who lacks financial or legal training. And many software-enabled approaches require a long-term relationship, including interaction between the user and the software during the lifetime of the trust. Since a life trust can be expected to outlive many generations of computer hardware and operating systems, this inevitably requires a user to obtain numerous revisions and updates to the software over a period of years. The user therefore encounters long-term expenses, and must be willing to accept the risk that the supplier of the software may not be able to provide all of the needed revisions and updates, or may not even remain in business, during the full lifetime of the trust.

### SUMMARY OF THE INVENTION

An improved, software-implemented system and method are claimed for enabling user-creation of an irrevocable life trust for a child with little or no help from an attorney, and without any need to pay for ongoing administrative or investment services, either from an attorney or from any other outside administrator or advisor. The life trust is preferably created when the child is still an infant, so as to allow as much time as possible for the trust to grow. The claimed invention avoids the cost and complexity of known methods by focusing exclusively on the creation of life trusts for children, without attempting to provide other financial services or investments, and without attempting to provide software-enabled support for long-term trust administration services. In this way, the claimed invention does not require ongoing use of the software, and thereby avoids any need for future software revisions and/or software upgrades.

Preferred embodiments of the method of the invention include raising public awareness and educating individuals regarding the desirability of life trusts in general, and of the possibility and benefits of self-created and self-administered life trusts for infants and children in particular. In some embodiments, an online calculator is provided that can be used to predict the financial benefits of a life trust. Once a user has decided to create a life trust, the invention provides a set of documents, instructions, and software that enable the user to create a legally enforceable trust document for an infant or a child without the assistance of an attorney. In particular, the software presents to the user at least one template, which is completed by the user and then used by the software to create one or more life trust documents.

In preferred embodiments the documents and instructions also provide information useful to the end user, and to the trustee of the life trust, regarding the operation and administration of a life trust. In some preferred embodiments, the instructions recommend that an attorney review the resulting trust documents before they are implemented, so as to address any specific issues and circumstances that may be unique to the end user. The present invention thereby provide a “turnkey” method that can be implemented by a user at a cost that is far lower than the cost of hiring an attorney to draft the required life trust documents, and which costs less over the long run by not requiring the use of an outside trust administrator.

In preferred embodiments, the claimed invention enables a life trust trustee to acquire, on behalf of the life trust, a tax-deferred annuity, which is a particularly appropriate investment for a life trust. Generally, when an annuity is held by a trust, or by anyone other than a natural person, the tax-deferral characteristic of the annuity is lost. However, preferred embodiments of the present invention allow an annuity to maintain its tax-deferred status by configuring the life trust to act solely as an agent for the life trust beneficiary. In this way, the tax-deferral aspect of the annuity is preserved even though the annuity is held in a trust. The administration of the life trust is thereby greatly simplified, due to the absence of current taxable income and because there are minimal or no income tax or other reporting requirements during the asset accumulation phase of the life trust.

The software of the present invention is supplied to users by any convenient means known in the art, such as on a compact disk, a flash drive, a memory stick, by internet download, and such like. In preferred embodiments, the software further includes usage limiting features intended to inhibit unauthorized use or copying of the life trust document package. These features can include password protection and duplication inhibiting features. In further preferred embodiments, use of the template(s) and/or other features of the software is tracked by the software and/or reported via the internet to a server maintained by the supplier of the software, thereby permitting enforcement of a usage limit and/or the charging of per-use fees. For example, in preferred embodiments these usage limiting features allow the documents to be sold at a lower price for personal use, and at a higher price for commercial use. One general aspect of the present invention is a software implemented system for facilitating establishment of a life trust by a user who is not a lawyer. The software implemented system is an article of manufacture that includes educational materials that motivate a user to create a life trust for a child, and media containing software that is dedicated exclusively to facilitating establishment of at least one life trust for a child, the software being able to direct the actions of a computer so as to cause the computer to present to the user at least one life trust template for completion by the user so as to create the life trust for the child, and using a completed version of the at least one life trust template, provide to the user at least one life trust document that can be executed so as to establish a life trust for the child.

In preferred embodiments, the software implemented system further includes supporting materials that are able to assist the user to establish a life trust and/or maintain a life trust. In some of these preferred embodiments the supporting materials include printed materials, materials that the software can cause to be presented on the computer, and/or materials that the software can cause to be printed by a computer.

In other of these embodiments the supporting materials include at least one of the following:

an overview notice addressing issues pertinent to life trusts;

instructions for creating a life trust;

a sample life trust document;

a summary of life trust document provisions, the summary facilitating an understanding of legal issues regarding life trust documents;

sample forms for administering a life trust;

a life trust handbook that provides a detailed explanation of issues related to life trusts;

a summary of duties of a life trust trustee that is able to facilitate proper operation of a life trust by a trustee;

a completed sample of an employer identification number application form; and

a completed sample of a federal gift tax return.

In some of these embodiments, the sample forms for administering a life trust include a beneficiary contribution withdrawal notice and/or a trustee resignation form. And in other of these embodiments the life trust handbook provides a detailed explanation of issues related to operation of a life trust, funding of a life trust, administration of a life trust, and/or tax issues relevant to a life trust.

In certain embodiments that include supporting materials that are able to assist the user to establish a life trust and/or maintain a life trust, the supporting materials include a recommendation that the user consult an attorney before establishing a life trust.

In preferred embodiments, at least one of the life trust templates is a sample life trust document with blanks that can be filled in to complete the life trust document. In other preferred embodiments, agreement by the user to at least one of a licensing agreement and a usage agreement is required before the software will provide a life trust document.

In certain preferred embodiments, the software includes a usage limiting feature that limits usage of the software. In some of these embodiments, the usage limiting feature is one of the following:

a requirement that the user enter an authorizing identification number before a life trust document is provided;

a requirement that the user enter an authorizing password before a life trust document is provided;

a requirement that the software communicate with a usage tracking server and obtain permission therefrom before providing a life trust document;

a requirement that the software operate on a usage tracking server accessible to the user over a network, and that the software provide the at least one life trust document in a format that inhibits modification;

a requirement that at least one life trust document include an imbedded watermark;

a requirement that the at least one life trust document include a background fill that inhibits successful photocopying and scanning;

encryption of at least one of the life trust templates;

a requirement that at least one of the life trust documents be encrypted; and

tracking by the software of a number of times a life trust template has been opened, and preventing opening thereof if it has been opened more than a specified number of times.

In some of these embodiments, the watermark includes a unique software identifying number, a notice indicating that the life trust document is proprietary in nature, a notice indicating that the life trust document is copyrighted, and/or a notice that the use of the life trust document is granted pursuant to a license.

In other embodiments that include a usage limiting feature that limits usage of the software, the usage limiting feature does not limit usage of the at least one life trust document. And in still other of these embodiments if the usage limiting feature detects that a specified usage limit has been reached, the software enables purchase by the user of additional usage.

In preferred embodiments, the software enables insertion of a nonstandard provision into at least one life trust document according to addition of the nonstandard provision to the at least one life trust document, and/or substitution of the nonstandard provision for a standard provision in the at least one life trust document. And in some of these embodiments the nonstandard provision is selectable from a list.

In various preferred embodiments the software implemented system enables a user to establish an annuity as an investment for the life trust without loss of the annuity's tax-deferral characteristics.

Another general aspect of the present invention is a method for facilitating establishment of a life trust by a user who is not a lawyer. The method includes providing to the user information that promotes establishing a life trust for a child, providing to the user information regarding benefits of a self-created life trust, and providing to the user a software implemented system for facilitating establishment of a life trust by a user who is not a lawyer, the software implemented system being an article of manufacture comprising media containing software that is dedicated exclusively to facilitating establishment of at least one life trust for a child, the software being able to direct the actions of a computer so as to cause the computer to present to the user at least one life trust template for completion by the user so as to create the life trust for the child, and using a completed version of the at least one life trust template, provide to the user at least one life trust document that can be executed so as to establish a life trust for the child.

In preferred embodiments, the software implemented system includes support materials configured so as to assist the user in establishing a life trust and/or maintaining a life trust. And in other preferred embodiments the software includes a usage limiting feature.

### BRIEF DESCRIPTION OF THE DRAWINGS

The invention will be more fully understood by reference to the detailed description, in conjunction with the following figures, wherein:

FIG. 1 is a flow diagram illustrating the method of the invention in a preferred embodiment to create a life trust;

FIG. 2 is a flow diagram illustrating interaction of the software in a preferred embodiment with a server over the internet so as to track and/or limit usage of the invention; and

FIG. 3 is a flow diagram illustrating a preferred embodiment that limits usage without interacting with a server by tracking the number of times that a document creation template has been used.

### DETAILED DESCRIPTION OF PREFERRED EMBODIMENTS

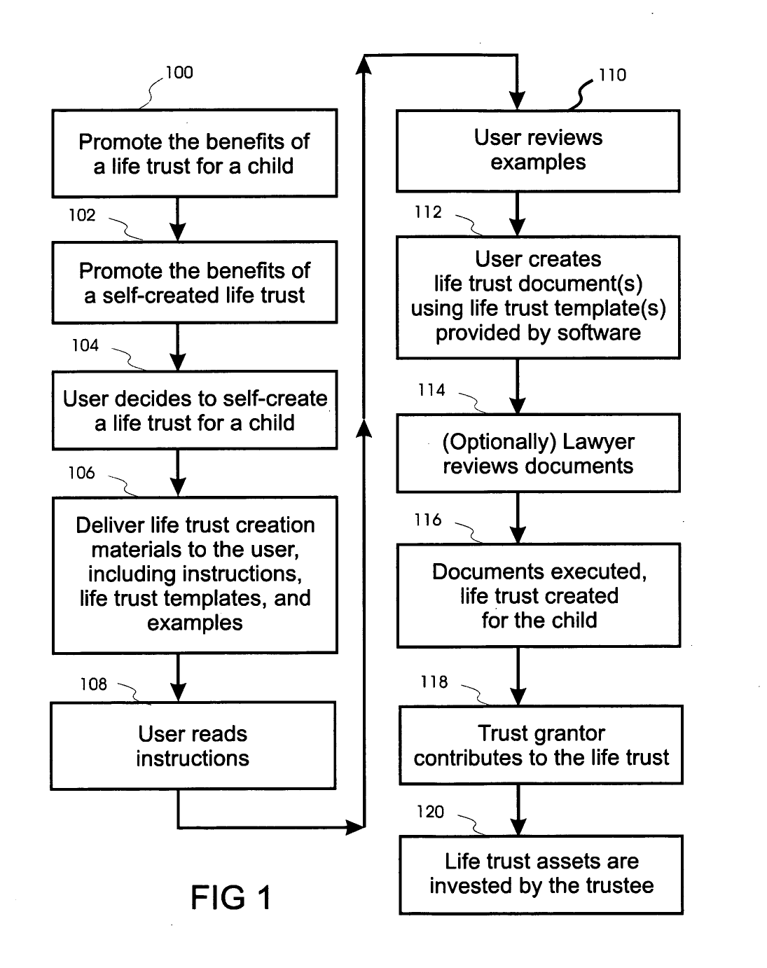

With reference to FIG. 1, in a preferred embodiment the method of the present invention begins with promotion of the value and benefits of creating a life trust 100 for an infant or a child. These benefits include long-term financial growth for the beneficiary that is low cost, tax-deferred, and asset protected, as well as other benefits for both the beneficiary and the creator of the life trust, including intangibles such as peace of mind, a sense of financial security and, for the life trust grantor, the creation of a legacy. The promotion can be by any means known in the art, such as commercial advertising, establishment of a website, distribution of printed materials, presenting of informational lectures, and such like.

Once a potential user is convinced of the value of creating a life trust, the embodiment of FIG. 1 continues by promoting the advantages of self-preparation of a life trust using the present invention 102. These advantages include direct control over the process, and avoidance of the high costs of an attorney.

Once the user decides 104 to create a life trust using the present invention, delivery is made 106 to the user of the life trust document package, including educational materials that motivate a user to create a life trust for an infant or a child, life trust document templates, instructions, software, and related materials. In preferred embodiments, these materials can include any or all of the following:

a sample life trust document, with blanks for easy completion;

instructions for creating the life trust;

an overview notice addressing various life trust matters that the end user should be aware of;

a summary of the principal life trust provisions, to facilitate understanding of the legal life trust document;

sample forms for administering the life trust, including a beneficiary withdrawal notice and trustee resignation forms;

a life trust handbook that explains in detail life trust operations, funding considerations, administration issues, tax matters and other relevant information;

a summary of the duties of a life trust trustee, to facilitate the proper operation of the life trust by the trustee; and

a sample completed employer identification number application form (IRS Form SS-4) and a sample completed Federal gift tax return, and related instructions (IRS Form 709).

In preferred embodiments, most or all of these materials are provided in a software format, and the software is operable on a personal computer or on a server accessible through the internet so as to facilitate creation of documents usable to establish a life trust.

The user then proceeds to read the instructions 108, review the explanatory and example materials 110, agree to any licensing and usage restrictions, and create a life trust document using the life trust document template 112. While not required by law, the instructions further encourage the user to consult with a competent attorney 114 to either address specific facts and circumstances, or to review either the life trust document template or the final life trust document for appropriateness. In any event, this consultation with an attorney will be at a much lower cost than if an attorney had prepared the documents without the benefit of the present invention. The life trust is then created for the infant or child when it is executed by the life trust grantor and the life trust trustee 116. The life trust grantor makes a contribution to the life trust 118, and the contribution (and any subsequent contributions) are invested by the life trust trustee 120, in accordance with the terms of the life trust and taking into account the information provided in the life trust document package.

Preferred embodiments of the present invention include features intended to limit usage of the invention, so as to allow the invention to be licensed for personal use at an affordable rate, while commercial rates and/or usage fees are charged to users who use the invention for business purposes. In preferred embodiments, this is accomplished by communication between a local copy of the software of the present invention and a server maintained by the provider of the software that tracks the usage of each software copy. For example, in some embodiments copies of the software that are used only once, or only a limited number of times, are assumed to have been used only for the personal benefit of the user, while copies of the software that are used a large number of times are assumed to have been used as part of a business that provides life trust creation services.

In similar embodiments, the software of the present invention is operable on a server computer and accessed over the internet. In these embodiments, documents are created by the server software and then downloaded by the user over the internet in a format that is not modifiable, such as a PDF file. In some of these embodiments, the downloaded documents also contain imbedded watermarks, encryption, and/or other features that inhibit unauthorized revision or reuse.

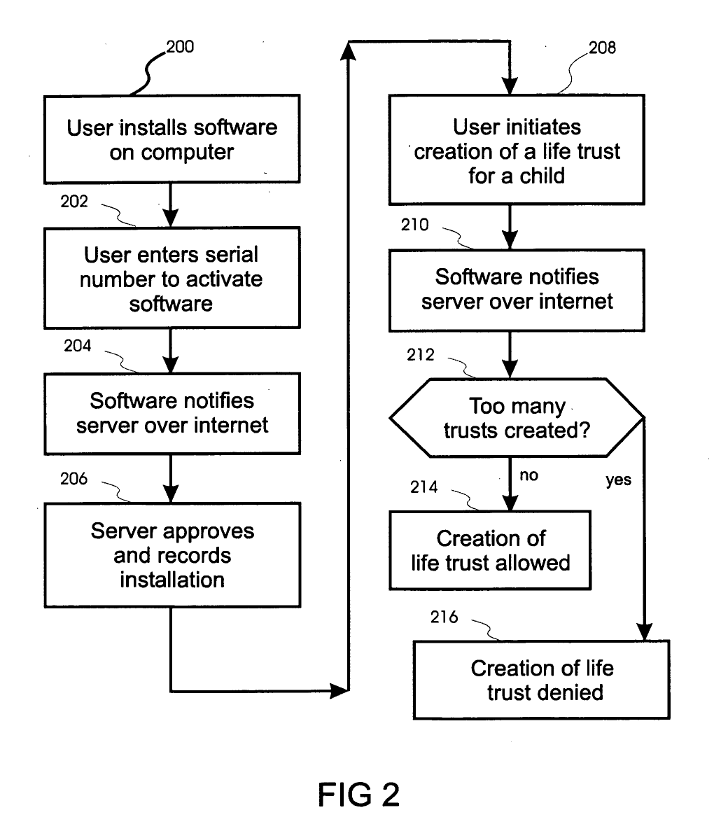

In the preferred embodiment of FIG. 2, a user installs a local copy of the software on a personal computer 200 and enters a unique serial number 202, and/or a user ID and password, to verify that the copy was properly licensed by the provider. Upon installation, the local copy of the software communicates over the internet with a server maintained by the provider of the invention 204, and the server verifies the validity of the serial number and records the installation 206 for future tracking of usage of the local copy.

Each time the user initiates creation of a life trust for an infant or child 208, the software notifies the server 210. If a specified maximum usage has not been exceeded 212, the usage is authorized by the server, and creation of the life trust is allowed 214. If the maximum usage has been exceeded, the creation of the life trust is denied 216.

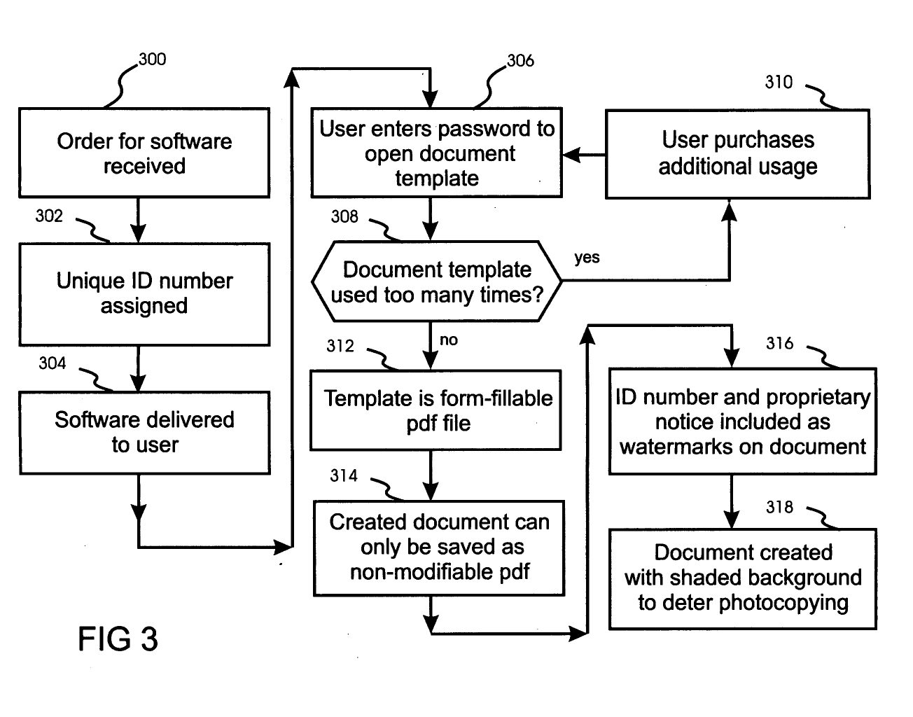

FIG. 3 illustrates features included in another embodiment that limit usage and discourage unauthorized duplication of the software. The process beings when an order is received 300 for the software of the present invention, either for an entire package or for an individual document template. The order can be received by any means commonly known in the art, such as by email receipt of a completed form with payment information, by receipt of a paper mail delivery with a completed form and a check, or via an ecommerce shopping cart or similar electronic transaction.

Once the order is received, a unique identification (“ID”) number or reference number is assigned to the purchase 302. In various embodiments, this can be a user identification assigned by the end user, or it can be assigned by the supplier of the software.

The software is then delivered 304 to the user, using any appropriate means known in the art, such as download from an internet site, or physical delivery on a medium such as a CD, DVD, flash drive, memory stick, or any such like. The user then proceeds to load the software onto a personal computer.

So as to create a trust document for an infant or a child, the user then enters a password 306 to open a document template 306. In preferred embodiments, the software keeps track of how many times the template has been used, and determines if a usage limit has been exceeded 308. If the limit has been exceeded 310, the user is given an opportunity to purchase additional usage from the software supplier. If the usage limit has not yet been exceeded, then the template is opened and is used to create the desired trust document. In preferred embodiments, the template is a pdf form 312 that allows information to be inserted so as to customize the form for creating a specific trust. In preferred embodiments, the trust document template includes a schedule that enables the inclusion and/or substitution of nonstandard provisions that supplement and/or override the standard provisions of the document.

Once the pdf form has been completed, the desired document is created as a non-modifiable pdf file 314. While this final document can be opened and copied as many times as desired, it cannot be modified without re-opening the template from which it was created. In preferred embodiments, the unique ID number and/or other identifying or features that serve to limit unauthorized copying or use are included in the document as a permanent watermark, as well as a notice indicating that the document is proprietary in nature, and its use is granted pursuant to a license 316. In some preferred embodiments, a shading or background fill is also included 318, so as to deter photocopying and scanning of the document, and also so as to enhance the unique appearance of the document.

Other modifications and implementations will occur to those skilled in the art without departing from the spirit and the scope of the invention as claimed. Accordingly, the above description is not intended to limit the invention except as indicated in the following claims.

What is claimed is:

1. A software implemented system for facilitating establishment of a life trust by a user who is not a lawyer, the software implemented system being an article of manufacture comprising:
educational materials that motivate a user to create a life trust for a child; and
media containing software that is dedicated exclusively to facilitating establishment of at least one life trust for a child, the software being able to direct the actions of a computer so as to cause the computer to:
present to the user at least one life trust template for completion by the user so as to create the life trust for the child; and
using a completed version of the at least one life trust template, provide to the user at least one life trust document that can be executed so as to establish a life trust for the child.

2. The software implemented system of claim 1, further comprising supporting materials that are able to assist the user to at least one of:
establish a life trust; and
maintain a life trust.

3. The software implemented system of claim 2, wherein the supporting materials include at least one of:
printed materials;
materials that the software can cause to be presented on the computer; and
materials that the software can cause to be printed by a computer.

4. The software implemented system of claim 2, wherein the supporting materials include at least one of:
an overview notice addressing issues pertinent to life trusts;
instructions for creating a life trust;
a sample life trust document;
a summary of life trust document provisions, the summary facilitating an understanding of legal issues regarding life trust documents;
sample forms for administering a life trust;
a life trust handbook that provides a detailed explanation of issues related to life trusts;
a summary of duties of a life trust trustee that is able to facilitate proper operation of a life trust by a trustee;
a completed sample of an employer identification number application form; and
a completed sample of a federal gift tax return.

5. The software implemented system of claim 4, wherein the sample forms for administering a life trust include at least one of:
a beneficiary contribution withdrawal notice; and
a trustee resignation form.

6. The software implemented system of claim 4, wherein the life trust handbook provides a detailed explanation of issues related to at least one of:
operation of a life trust;
funding of a life trust;
administration of a life trust; and
tax issues relevant to a life trust.

7. The software implemented system of claim 2, wherein the supporting materials include a recommendation that the user consult an attorney before establishing a life trust.

8. The software implemented system of claim 1, wherein at least one of the life trust templates is a sample life trust document with blanks that can be filled in to complete the life trust document.

9. The software implemented system of claim 1, wherein agreement by the user to at least one of a licensing agreement and a usage agreement is required before the software will provide a life trust document.

10. The software implemented system of claim 1, wherein the software includes a usage limiting feature that limits usage of the software.

11. The software of claim 10, wherein the usage limiting feature is one of:
a requirement that the user enter an authorizing identification number before a life trust document is provided;
a requirement that the user enter an authorizing password before a life trust document is provided;
a requirement that the software communicate with a usage tracking server and obtain permission therefrom before providing a life trust document;
a requirement that the software operate on a usage tracking server accessible to the user over a network, and that the software provide the at least one life trust document in a format that inhibits modification;
a requirement that at least one life trust document include an imbedded watermark;
a requirement that the at least one life trust document include a background fill that inhibits successful photocopying and scanning;
encryption of at least one of the life trust templates;
a requirement that at least one of the life trust documents be encrypted; and
tracking by the software of a number of times a life trust template has been opened, and preventing opening thereof if it has been opened more than a specified number of times.

12. The software implemented system of claim 11, wherein the watermark includes at least one of:
a unique software identifying number;
a notice indicating that the life trust document is proprietary in nature;
a notice indicating that the life trust document is copyrighted; and
a notice that the use of the life trust document is granted pursuant to a license.

13. The software implemented system of claim 10, wherein the usage limiting feature does not limit usage of the at least one life trust document.

14. The software implemented system of claim 10, wherein if the usage limiting feature detects that a specified usage limit has been reached, the software enables purchase by the user of additional usage.

15. The software implemented system of claim 1, wherein the software enables insertion of a nonstandard provision into at least one life trust document according to at least one of:
addition of the nonstandard provision to the at least one life trust document; and
substitution of the nonstandard provision for a standard provision in the at least one life trust document.

16. The software implemented system of claim 15, wherein the nonstandard provision is selectable from a list.

17. The software implemented system of claim 1, wherein the software implemented system enables a user to establish an annuity as an investment for the life trust without loss of the annuity's tax-deferral characteristics.

18. A method for facilitating establishment of a life trust by a user who is not a lawyer, the method comprising:
providing to the user information that promotes establishing a life trust for a child;
providing to the user information regarding benefits of a self-created life trust; and
providing to the user a software implemented system for facilitating establishment of a life trust by a user who is not a lawyer, the software implemented system being an article of manufacture comprising media containing software that is dedicated exclusively to facilitating establishment of at least one life trust for a child, the software being able to direct the actions of a computer so as to cause the computer to present to the user at least one life trust template for completion by the user so as to create the life trust for the child, and using a completed version of the at least one life trust template, provide to the user at least one life trust document that can be executed so as to establish a life trust for the child.

19. The method of claim 18, wherein the software implemented system includes support materials configured so as to assist the user in at least one of:
establishing a life trust; and
maintaining a life trust.

20. The method of claim 18, wherein the software includes a usage limiting feature.
